(19) United States
(12) Patent Application Publication
(10) Pub. No.: US 2025/0331078 A1
(43) Pub. Date: Oct. 23, 2025

(54) CIRCUITRY TO CONTROL COMMON CATHODE BI-COLOR LEDS IN STORAGE DEVICES

(71) Applicant: SanDisk Technologies LLC, Austin, TX (US)

(72) Inventor: DIBIN GANGADHARAN, Bangalore (IN)

(73) Assignee: SanDisk Technologies LLC, Austin, TX (US)

(21) Appl. No.: 18/640,785

(22) Filed: Apr. 19, 2024

(51) Int. Cl. H05B 45/20

(52) U.S. Cl. CPC H05B 45/20

(57) ABSTRACT

A storage device includes a bi-color control circuitry to control states of a bi-color light-emitting diode (LED). The circuitry includes materials used on other components in the storage device, thus reducing the bill of materials needed to configure the storage device. The circuitry includes a bi-color LED, a first current limit resistor, and a second current limit resistor. The first current limit resistor and the second current limit resistor are different value resistors. The circuitry also includes a first set of materials that contribute to turning on and/or turning off the states of the bi-color LED. The first set of materials is used in at least one other component in the storage device. The first set of materials, the first current limit resistor, and the second current limit resistor change the states of the bi-color LED according to a host signal received by the bi-color control circuitry.

### BACKGROUND OF THE INVENTION

A storage device may be communicatively coupled to a host and to non-volatile memory including, for example, a NAND flash memory device on which the storage device may store data received from the host. The features of the storage device including, for example, the form factor of the storage device and other features provided by one or more types of storage devices may be configured according to predefined specifications. For example, for an enterprise and datacenter solid state storage drive (E3) form factor, a specification may define how controls for one or more bi-color light-emitting diodes (LEDs) may be configured. The specification may define bi-color LED states for an amber/blue LED which may be driven by a host signal through a LED pin of a connector between the storage device and the host.

The specification may define that the bi-color amber/blue LED may operate in three LED states. In a first/asserted state when the LED signal is driven high, an amber LED state may be turned on and a blue LED state may be turned off. In a second/de-asserted state, when the LED signal is driven low, the amber LED state may be turned off and the blue LED state may be turned on. In a third/high impedance state, both the amber LED and the blue LED may be turned off.

To control the amber and blue LEDs per the specification, a current amber/blue bi-color control circuitry (referred to herein as a first bi-color control circuitry) uses a common anode bi-color amber/blue LED, dual NPN bipolar junction transistors (BJT), one diode, and four different value resistors. Another current amber/blue bi-color circuitry (referred to herein as a second bi-color control circuitry), which may be used as an alternative to the first bi-color control circuitry, uses a common cathode bi-color amber/blue LED, dual NPN BJTs, and five different value resistors.

The specifications used for configuring other features/components of the storage device do not use the different value resistors, the common anode bi-color amber/blue LED, the NPN BJTs, and the diode used in the first bi-color control circuitry. Similarly, the specifications used for configuring other components of the storage device do not use the common cathode bi-color amber/blue LED, the dual NPN BJTs, and five different value resistors used in the second bi-color control circuitry. As such, when a storage device is configured according to the bi-color amber/blue LED specification, in addition to the other materials needed to configure the other components of the storage device, the materials for the first bi-color control circuitry or the second bi-color control circuitry must be procured. This increases the bill of materials required to configure the storage device which may increase the overall cost of the storage device.

### SUMMARY OF THE INVENTION

In some implementations, a bi-color control circuitry controls states of a bi-color light-emitting diode (LED) and includes materials used on other components in a storage device. The bi-color control circuitry includes a bi-color LED. The bi-color control circuitry also includes a first current limit resistor and a second current limit resistor, the first current limit resistor and the second current limit resistor being different value resistors. The bi-color control circuitry further includes a first set of materials contributing to turning on and/or turning off the states of the bi-color LED. The first set of materials is used in at least one other component in the storage device, thus reducing the bill of materials needed to configure the storage device. The first set of materials, the first current limit resistor, and the second current limit resistor change the states of the bi-color LED according to a host signal received by the bi-color control circuitry.

In some implementations, the bi-color control circuitry includes a bi-color LED, a first current limit resistor, and a second current limit resistor. The first current limit resistor and the second current limit resistor are different value resistors. The bi-color control circuitry also includes a first set of materials contributing to turning on and/or turning off the states of the bi-color LED. The first set of materials is used in at least one other component in the storage device and the first set of materials includes a first metal-oxide-semiconductor field-effect transistor (MOSFET), a second MOSFET, a first resistor, and a second resistor placed between the second MOSFET and an LED. The first resistor and the second resistor have the same value. The first set of materials, the first current limit resistor, and the second current limit resistor change the states of the bi-color LED according to a host signal received by the bi-color control circuitry.

In some implementations, a method is provided for controlling states of a bi-color light-emitting diode (LED) using a bi-color control circuitry that includes materials used on other components in a storage device, the method includes receiving a host signal via a LED pin connecting the storage device and a host. The method also includes determining that the LED pin is asserted, turning an amber LED into a forward state, flowing current through a current limit resistor, and allowing the host signal to go through a first MOSFET to turn on the first MOSFET and allow the current to pass through the first MOSFET and short a gate voltage of a second MOSFET so that the second MOSFET is placed in an off state which turns a blue LED to the off state. The method further includes determining that the LED pin is de-asserted such that no current flows to the amber LED, the amber LED is turned to the off state, a gate of the first MOSFET gets the low host signal and the first MOSFET is turned off so that no current flows through the first MOSFET which turns off the first MOSFET and turns on the second MOSFET, and turns the blue LED into the forward state. The method also includes determining that there is a high impedance such that the current that flows through a first resistor and a first current limit resistor is insufficient to turn on the amber LED, and the current turns on the first MOSFET which turns off the second MOSFET and puts the blue LED in the off state.

### BRIEF DESCRIPTION OF THE DRAWINGS

FIG. 1 shows example views of enterprise and datacenter solid state storage devices having a given form factor.

FIG. 2 shows a schematic of a first amber/blue bi-color control circuitry that is currently used in storage device 104.

FIG. 3 shows a schematic of a second amber/blue bi-color control circuitry that is also currently used in storage device 104.

FIG. 4 shows a schematic of a third amber/blue bi-color control circuitry used in storage device 104 in accordance with some implementations.

FIG. 5 shows a schematic of a fourth amber/blue bi-color control circuitry used in storage device 104 in accordance with some implementations.

FIG. 6 is a flow diagram of an example process for controlling the states of an amber/blue LED in a storage device in accordance with some implementations.

FIG. 7 is a diagram of an example environment in which systems and/or methods described herein are implemented.

FIG. 8 is a diagram of example components of one or more devices of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

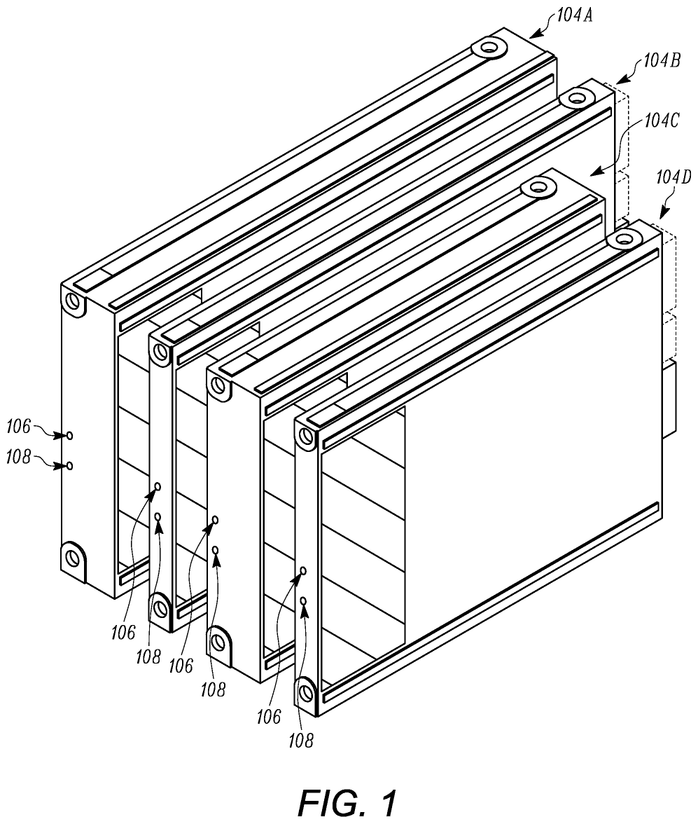

FIG. 1 shows example views of enterprise and datacenter solid state storage devices having a given form factor. A host 102 (not shown in this figure for the sake of simplicity) may be connected to a storage device 104 (i.e., one of storage devices 104a, 104b, 104c, or 104d, referred to generally as storage device(s) 104) having a form factor as depicted in FIG. 1. Host 102 and storage device 104 may be in the same physical location as components on a single computing device or on different computing devices that are communicatively coupled. Storage device 104, in various embodiments, may be disposed in one or more different locations relative to the host 102.

A specification defining features for storage devices 104, having the form factor shown in FIG. 1, may define one or more bi-color light-emitting diode (LED) states. The front of each storage device 104 may provide holes 106 and 108 to display the current LED states. For instance, a green LED or a green/white bi-color LED that may be used to indicate the overall status of storage device 104 may be displayed through hole 106 (also referred to herein as a first hole). The green element may be controlled by firmware on storage device 104. The white element may be displayed on storage device 104 when an indication is provided by storage device 104 when it is safe to remove storage device 104 from host 102. The white element, when provided, may also be controlled by firmware on storage device 104.

An amber/blue bi-color LED that may indicate when storage device 104 is in a fault condition or when host 102 needs to identify storage device 104 in a chassis may be displayed in hole 108 (also referred to herein as a second hole). The amber and blue elements of the LED may be controlled by a host signal through a LED pin of a storage device-host connector. The specification associated with this form factor of storage device 104 may define that the bi-color amber/blue LED may operate in three LED states. In a first/asserted state when the LED signal is driven high, an amber LED state may be turned on and a blue LED state may be turned off. In a second/de-asserted state, when the LED signal is driven low, the amber LED state may be turned off and the blue LED state may be turned on. In a third/high impedance state, both the amber LED and the blue LED may be turned off. FIG. 1 is provided as an example. Other examples may differ from what is described in FIG. 1.

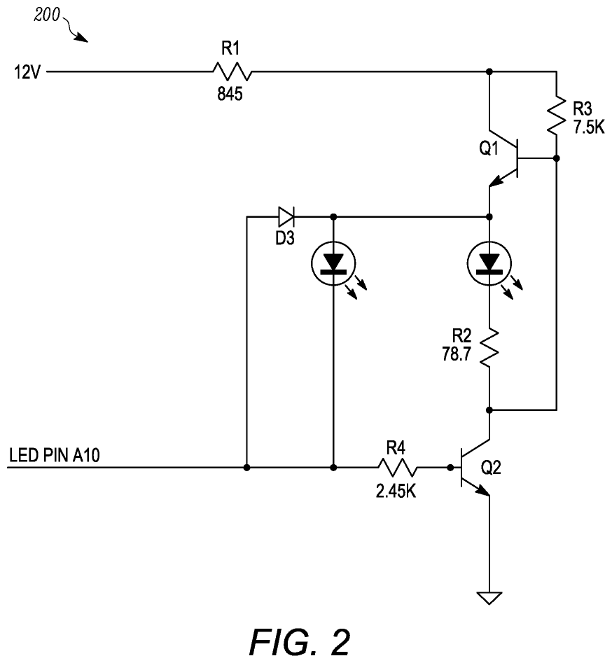

FIG. 2 shows a schematic of a first amber/blue bi-color control circuitry that is currently used in storage device 104. First amber/blue bi-color control circuitry 200 may be used to control the states of the amber/blue bi-color LED. First amber/blue bi-color control circuitry 200 includes four resistors (R1, R2, R3, and R4), each with a different value. As shown, R1 is an 845-ohm resistor, R2 is a 78.7-ohm resistor, R3 is a 7.5K resistor, and R4 is a 2.45K resistor. First amber/blue bi-color control circuitry 200 also includes a common anode bi-color amber/blue LED, a diode (D3) and two transistors (Q1 and Q2). Based on the specifications used to configure storage device 104, each of the materials (the common anode bi-color amber/blue LED, R1, R2, R3, R4, D3, Q1, and Q2) of first amber/blue bi-color control circuitry 200 are not reused in other components of storage device 104, thus increasing the bill of materials (BOM) when first amber/blue bi-color control circuitry 200 is used in storage device 104. FIG. 2 is provided as an example. Other examples may differ from what is described in FIG. 2.

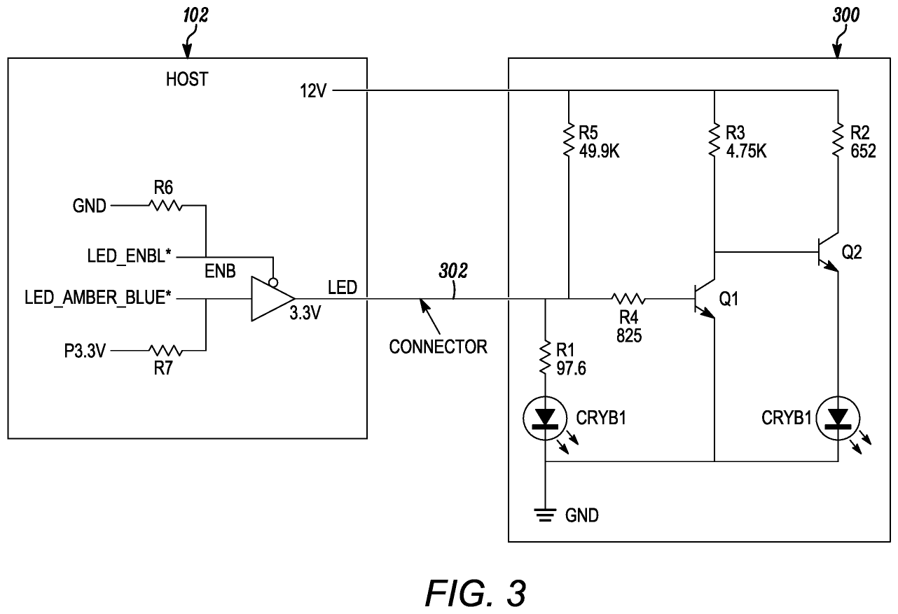

FIG. 3 shows a schematic of a second amber/blue bi-color control circuitry that is also currently used in storage device 104. Second amber/blue bi-color control circuitry 300 may also be used to control the states of the amber/blue bi-color LED and as an alternative to first amber/blue bi-color control circuitry 200. Second bi-color control circuitry 300 includes five resistors (R1, R2, R3, R4, and R5), each with a different value. R1 is a 97.6-ohm resistor, R2 is a 65.2-ohm resistor, R3 is a 4.75K resistor, R4 is an 825-ohm resistor, and R5 is a 49.9K resistor. The second amber/blue bi-color control circuitry 300 also includes a common cathode bi-color amber/blue LED and two transistors (Q1 and Q2). FIG. 3 shows that the second amber/blue bi-color control circuitry 300 is connected to host 102 via a drive-host connector 302. According to the specifications used to configure storage device 104, each of the materials (i.e., the common cathode bi-color amber/blue LED, R1, R2, R3, R4, R5, Q1, and Q2) of second amber/blue bi-color control circuitry 300 are also not reused in other components of storage device 104, thus increasing the BOM when second amber/blue bi-color control circuitry 300 is used in storage device 104. FIG. 3 is provided as an example. Other examples may differ from what is described in FIG. 3.

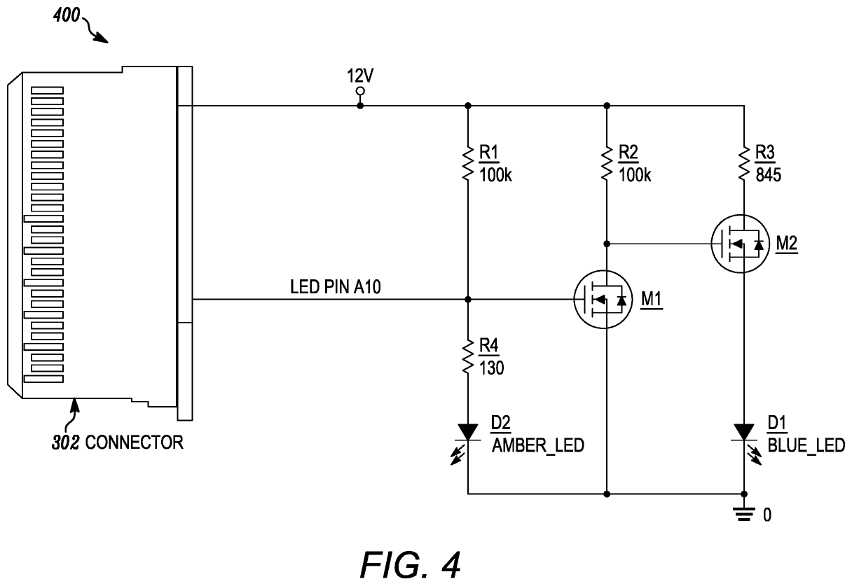

FIG. 4 shows a schematic of a third amber/blue bi-color control circuitry used in storage device 104 in accordance with some implementations. Third amber/blue bi-color control circuitry 400 may also be used to control the states of the amber/blue bi-color LED as an alternative to first amber/blue bi-color control circuitry 200 or second amber/blue bi-color control circuitry 300. Third amber/blue bi-color control circuitry 400 includes two metal-oxide-semiconductor field-effect transistors (MOSFETs (i.e., M1 (also referred to herein as a first MOSFET) and M2 (also referred to herein as a second MOSFET))) and two higher value resistors (R1 and R2). Although R1 and R2 are shown as 100K resistors, R1 and R2 may be other higher value resistors. M1, M2, R1, and R2 are also referred to herein as a first set of materials. According to the specifications used to configure components on storage device 104, the first set of materials are currently used in other components of storage device 104. Third amber/blue bi-color control circuitry 400 also includes an 845-ohm resistor (R3 and referred to herein as a first current limit resistor) and a 130-ohm resistor (R4 and referred to herein as a second current limit resistor) and a common cathode bi-color LED (D1 and D2). The values of R3 and R4 provided herein are examples and may vary depending on the light requirement of amber/blue bi-color LED. When storage device 104 is configured to include third amber/blue bi-color control circuitry 400 instead of first amber/blue bi-color control circuitry 200 or second amber/blue bi-color control circuitry 300, the reuse of MOSFETs M1 and M2 and resistors R1 and R2 (i.e., the first set of materials) will decrease the number of different materials that need to be procured and reduce the BOMs required to construct storage device 104.

Host 102 may control the amber/blue bi-color LED through LED pin A10, wherein when LED pin A10 is asserted (i.e. driven high) by host 102, M1 may be turned on and M2 may be turned off. LED pin A10 may be asserted when a high signal, for example, a 3.3V signal, is provided by host 102. The 3.3V signal may go through amber LED D2 to the ground. Amber LED D2 may turn into the forward state (i.e., the on state) and current may flow through current limit resistor, R4. The 3.3V signal may go through M1 and it may turn on M1 and the 12V may pass through M1. When the 12V is passing through M1, the gate voltage of M2 may be shorted with ground so M2 may be in an off state which may turn blue LED D1 to an off state.

LED pin A10 may be de-asserted when a low signal, for example, a 0V signal, is provided by host 102. When LED pin A10 is de-asserted (i.e., driven low), no current may flow to Amber LED D2 and Amber LED D2 may turn to the off state. When LED pin A10 is de-asserted, the gate of M1 may get 0V and M1 may be turned off so that no current may flow through M1. This may turn off M1 and turn M2 on. Blue LED D1 may turn into the forward state (i.e., the on state). Current from 12V may flow through R3 (current limit resistor), M2, and Blue LED D1.

When there is high impedance (i.e., LED pin A10 is not driven and there is no voltage on LED pin A10), 12V current may flow through R1 and R4 and the current flowing through Amber LED D2 may be approximately 100 uA which may be insufficient to turn on Amber LED D2. At the same time, the 12V may turn on M1 because of the R1 pullup resistor. This may turn off M2. Blue LED D1 may be in the off state and current passing through Blue LED D1 may be approximately 0 A. LED Pin A10 voltage will be the forward voltage of Amber LED D2, i.e., approximately 1.7V.

Amber LED D2 on and off states may be independent of the 12V flowing through amber/blue bi-color control circuitry 300. Even if the 12V is off, Amber LED D2 should be functioning as provided above (i.e., in the on state when the LED pin signal is asserted, in the off state when the LED pin signal is de-asserted, and in the off state during high impedance). 12V power may flow through Blue LED D1. So, Blue LED may be off if the 12V is not present.

In the first amber/blue bi-color control circuitry 200 and second amber/blue bi-color control circuitry 300, when amber LED D2 is on, current is continuously flowing through the transistor, which results in a power loss. Third amber/blue bi-color control circuitry 400 reduces continuously current loss, adds a reduced minimum number of components to the BOM for storage device 104, and takes up less printed circuit board (PCB) space, thus reducing the cost and power consumption of storage device 104. FIG. 4 is provided as an example. Other examples may differ from what is described in FIG. 4.

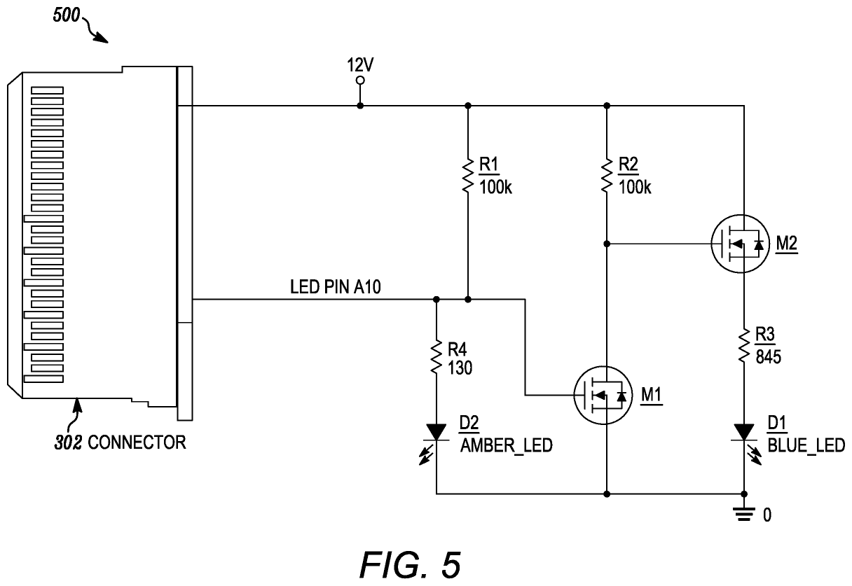

FIG. 5 shows a schematic of a fourth amber/blue bi-color control circuitry used in storage device 104 in accordance with some implementations. Fourth amber/blue bi-color control circuitry 500 may also be used to control the states of the amber/blue bi-color LED as an alternative to first amber/blue bi-color control circuitry 200 or second amber/blue bi-color control circuitry 300. Like third amber/blue bi-color control circuitry 400, fourth amber/blue bi-color control circuitry 500 includes a first set of materials (i.e., two MOSFETs (M1 and M2) and two higher value (for example, 100K) resistors (R1 and R2)) that may currently be used in other components of storage device 104 based on the specifications used to configure storage device 104. Fourth amber/blue bi-color control circuitry 500 also includes an 845-ohm resistor (R3) and a 130-ohm resistor (R4) and a common cathode bi-color LED. The values of R3 and R4 provided herein are examples and may vary depending on the light requirement of the amber/blue bi-color LED. When storage device 104 is configured to include fourth amber/blue bi-color control circuitry 500, the reuse of MOSFETs M1 and M2 and resistors R1 and R2 will decrease the number of different materials that may need to be procured and the BOMs required to construct storage device 104.

Fourth amber/blue bi-color control circuitry 500 may control the states of the amber/blue bi-color LED, the same as or like third amber/blue bi-color control circuitry 400. However, R3 in fourth amber/blue bi-color control circuitry 500 is placed between M2 and D1 (i.e., the blue LED) to control the gate source voltage of M2. Because of the controlled gate source voltage for M2, small signal MOSFETs may be used on fourth amber/blue bi-color control circuitry 500 and this circuitry may use different sized MOSFETs. FIG. 5 is provided as an example. Other examples may differ from what is described in FIG. 5.

Storage device 104 may perform these processes based on a processor, for example, a controller 112 executing software instructions stored by a non-transitory computer-readable medium, such as storage component 110. As used herein, the term “computer-readable medium” refers to a non-transitory memory device. Software instructions may be read into storage component 110 from another computer-readable medium or from another device. When executed, software instructions stored in storage component 110 may cause controller 112 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

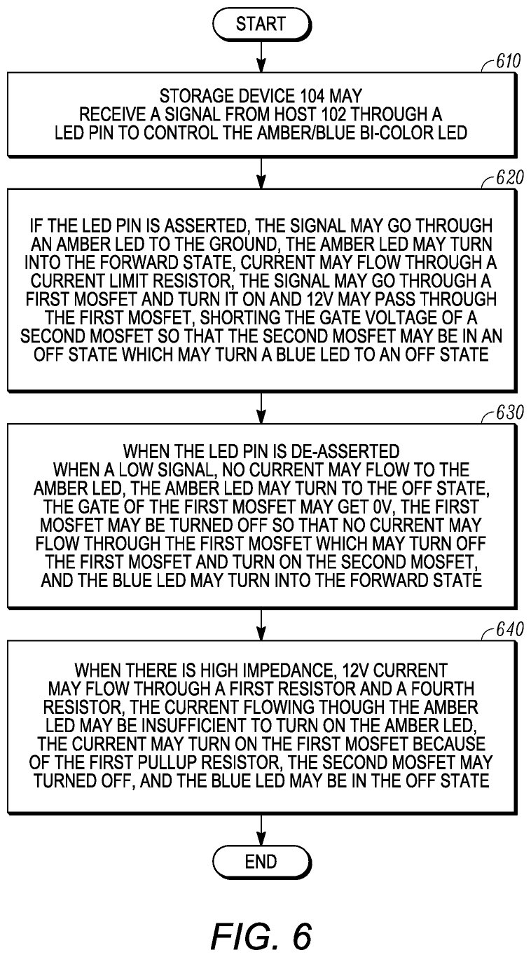

FIG. 6 is a flow diagram of an example process for controlling the states of an amber/blue LED in a storage device in accordance with some implementations. At 610, storage device 104 may receive a signal from host 102 through a LED pin to control the amber/blue bi-color LED. At 620, if the LED pin is asserted, the signal may go through an amber LED to the ground, the amber LED may turn into the forward state, current may flow through a current limit resistor, the signal may go through a first MOSFET and turn it on and 12V may pass through the first MOSFET, shorting the gate voltage of a second MOSFET so that the second MOSFET may be in an off state which may turn a blue LED to an off state.

At 630, when the LED pin is de-asserted when a low signal, no current may flow to the amber LED, the amber LED may turn to the off state, the gate of the first MOSFET may get 0V, the first MOSFET may be turned off so that no current may flow through the first MOSFET which may turn off the first MOSFET and turn on the second MOSFET, and the blue LED may turn into the forward state.

At 640, when there is high impedance, 12V current may flow through a first resistor and a fourth resistor, the current flowing though the amber LED may be insufficient to turn on the amber LED, the current may turn on the first MOSFET because of the first pullup resistor, the second MOSFET may turned off, and the blue LED may be in the off state. As indicated above FIG. 6 is provided as an example. Other examples may differ from what is described in FIG. 6.

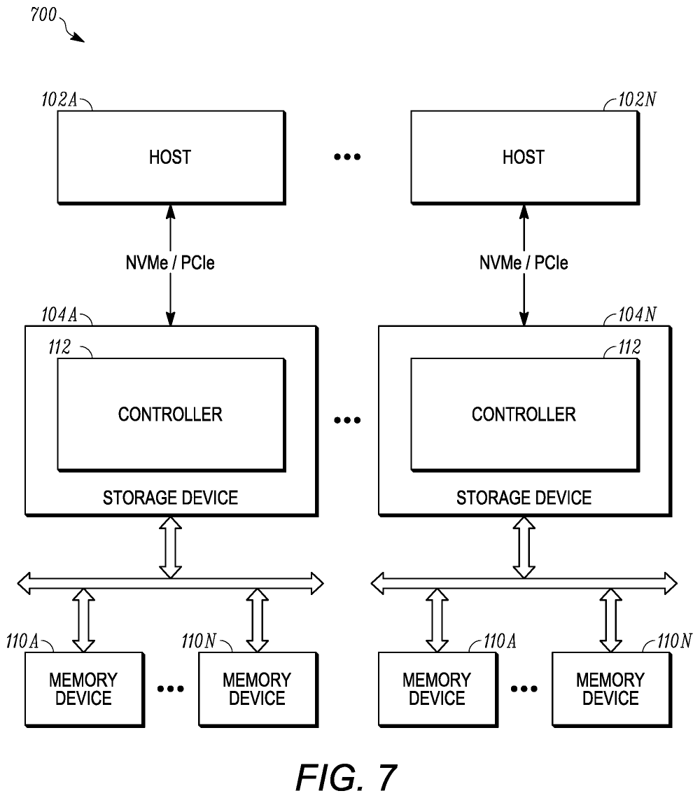

FIG. 7 is a diagram of an example environment in which systems and/or methods described herein are implemented. As shown in FIG. 7, Environment 700 may include hosts 102-102n (referred to herein as host(s) 102), and one or more storage devices 104a-104n (referred to herein as storage device(s) 104). Storage device 104 may include a controller 112 to control the states of the amber/blue LED. Hosts 102 and storage devices 104 may communicate via Non-Volatile Memory Express (NVMe) over peripheral component interconnect express (PCI Express or PCIe), or the like.

Devices of Environment 700 may interconnect via wired connections, wireless connections, or a combination of wired and wireless connections. For example, the network in FIG. 7 may include NVMe over Fabric (NVMe-oF) Internet Small Computer Systems Interface (iSCSI), Fibre Channel (FC), Fibre Channel Over Ethernet (FCOE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 7 are provided as an example. In practice, there may be additional devices and/or networks, fewer devices and/or networks, different devices and/or networks, or differently arranged devices and/or networks than those shown in FIG. 7. Furthermore, two or more devices shown in FIG. 7 may be implemented within a single device, or a single device shown in FIG. 7 may be implemented as multiple, distributed devices. Additionally, or alternatively, a set of devices (e.g., one or more devices) of Environment 700 may perform one or more functions described as being performed by another set of devices of Environment 700.

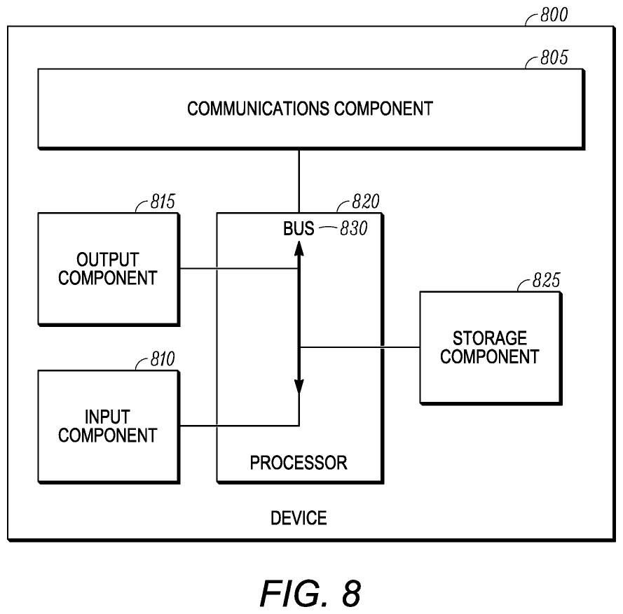

FIG. 8 is a diagram of example components of one or more devices of FIG. 1. In some implementations, host 102 may include one or more devices 800 and/or one or more components of device 800. Device 800 may include, for example, a communications component 805, an input component 810, an output component 815, a processor 820, a storage component 825, and a bus 830. Bus 830 may include components that enable communication among multiple components of device 800, wherein components of device 800 may be coupled to be in communication with other components of device 800 via bus 830.

Input component 810 may include components that permit device 800 to receive information via user input (e.g., keypad, a keyboard, a mouse, a pointing device, and a network/data connection port, or the like), and/or components that permit device 800 to determine the location or other sensor information (e.g., an accelerometer, a gyroscope, an actuator, another type of positional or environmental sensor). Output component 815 may include components that provide output information from device 800 (e.g., a speaker, display screen, and network/data connection port, or the like). Input component 810 and output component 815 may also be coupled to be in communication with processor 820.

Processor 820 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 820 may include one or more processors capable of being programmed to perform a function. Processor 820 may be implemented in hardware, firmware, and/or a combination of hardware and software.

Storage component 825 may include one or more memory devices, such as random-access memory (RAM), read-only memory (ROM), and/or another type of dynamic or static storage device (e.g., a flash memory, a magnetic memory, and/or optical memory) that stores information and/or instructions for use by processor 820. A memory device may include memory space within a single physical storage device or memory space spread across multiple physical storage devices. Storage component 825 may also store information and/or software related to the operation and use of device 800. For example, storage component 825 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, CXL device and/or another type of non-transitory computer-readable medium, along with a corresponding drive.

Communications component 805 may include a transceiver-like component that enables device 800 to communicate with other devices, such as via a wired connection, a wireless connection, or a combination of wired and wireless connections. The communications component 805 may permit device 800 to receive information from another device and/or provide information to another device. For example, communications component 805 may include an Ethernet interface, an optical interface, a coaxial interface, an infrared interface, a radio frequency (RF) interface, a universal serial bus (USB) interface, a Wi-Fi interface, and/or a cellular network interface that may be configurable to communicate with network components, and other user equipment within its communication range. Communications component 805 may also include one or more broadband and/or narrowband transceivers and/or other similar types of wireless transceiver configurable to communicate via a wireless network for infrastructure communications. Communications component 805 may also include one or more local area network or personal area network transceivers, such as a Wi-Fi transceiver or a Bluetooth transceiver.

Device 800 may perform one or more processes described herein. For example, device 800 may perform these processes based on processor 820 executing software instructions stored by a non-transitory computer-readable medium, such as storage component 825. As used herein, the term “computer-readable medium” refers to a non-transitory memory device. Software instructions may be read into storage component 825 from another computer-readable medium or from another device via communications component 805. When executed, software instructions stored in storage component 825 may cause processor 820 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 8 are provided as an example. In practice, device 800 may include additional components, fewer components, different components, or differently arranged components than those shown in FIG. 8. Additionally, or alternatively, a set of components (e.g., one or more components) of device 800 may perform one or more functions described as being performed by another set of components of device 800.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A bi-color control circuitry in a storage device, the bi-color control circuitry controls states of a bi-color light-emitting diode (LED) and includes materials used on other components in the storage device, the bi-color control circuitry comprises:
a bi-color LED;
a first current limit resistor and a second current limit resistor, the first current limit resistor and the second current limit resistor being different value resistors; and
a first set of materials contributing to one of turning on and turning off the states of the bi-color LED, wherein the first set of materials is used in at least one other component in the storage device and wherein the first set of materials, the first current limit resistor, and the second current limit resistor change the states of the bi-color LED according to a host signal received by the bi-color control circuitry.

2. The bi-color control circuitry of claim 1, wherein the first set of materials includes a first metal-oxide-semiconductor field-effect transistor (MOSFET), a second MOSFET, a first resistor, and a second resistor, the first resistor and the second resistor having a same value.

3. The bi-color control circuitry of claim 1, wherein the first current limit resistor is an 845-ohm resistor, and the second current limit resistor is a 130-ohm resistor.

4. The bi-color control circuitry of claim 1, wherein the values of the first current limit resistor and the second current limit resistor vary depending on a light requirement of the bi-color LED.

5. The bi-color control circuitry of claim 1, wherein the bi-color control circuitry receives the host signal through an LED pin connector between a host and the storage device.

6. The bi-color control circuitry of claim 1, wherein the bi-color LED is an amber LED and a blue LED, and when a high host signal is received by the bi-color control circuitry, the high host signal goes through the amber LED to ground, the amber LED turns into a forward state, and current flows through the first current limit resistor.

7. The bi-color control circuitry of claim 6, wherein the high host signal flows through a first MOSFET, turns the first MOSFET on and the current passes through the first MOSFET, shorting a gate voltage of a second MOSFET and turning the second MOSFET to an off state to turn off the blue LED.

8. The bi-color control circuitry of claim 1, wherein the bi-color LED is an amber LED and a blue LED, and when a low host signal is received by the bi-color control circuitry, no current flows to the amber LED and the amber LED is turned to an off state.

9. The bi-color control circuitry of claim 8, wherein a gate of a first MOSFET gets the low host signal, turns off the first MOSFET so that no current flows to the first MOSFET, turns on a second MOSFET, and moves the blue LED to a forward state, wherein current flows through the second current limit resistor and the blue LED.

10. The bi-color control circuitry of claim 1, wherein the bi-color LED is an amber LED and a blue LED, and when no host signal is received by the bi-color control circuitry, current flowing through a first resistor and a second resistor is insufficient to turn on the amber LED.

11. The bi-color control circuitry of claim 10, wherein the current turns on a first MOSFET and turns off a second MOSFET and the blue LED.

12. The bi-color control circuitry of claim 1, wherein the bi-color LED is an amber LED and a blue LED and the amber LED off and on states are independent of current flowing through the bi-color control circuitry.

13. The bi-color control circuitry of claim 1, wherein the bi-color LED is an amber LED and a blue LED, and the blue LED is in an off state when current is not present in the bi-color control circuitry.

14. A bi-color control circuitry in a storage device, the bi-color control circuitry controls states of a bi-color light-emitting diode (LED) and includes materials used on other components in the storage device, the bi-color control circuitry comprises:
a bi-color LED;
a first current limit resistor and a second current limit resistor, the first current limit resistor and the second current limit resistor being different value resistors; and
a first set of materials contributing to one of turning on and turning off the states of the bi-color LED, wherein the first set of materials is used in at least one other component in the storage device and the first set of materials includes a first metal-oxide-semiconductor field-effect transistor (MOSFET), a second MOSFET, a first resistor, and a second resistor placed between the second MOSFET and an LED, the first resistor and the second resistor having a same value,
wherein the first set of materials, the first current limit resistor, and the second current limit resistor change the states of the bi-color LED according to a host signal received by the bi-color control circuitry.

15. The bi-color control circuitry of claim 14, wherein the bi-color control circuitry uses different sized MOSFETs.

16. A method for controlling states of a bi-color light-emitting diode (LED) using a bi-color control circuitry that includes materials used on other components in a storage device, the method comprising:
receiving a host signal via a LED pin connecting the storage device and a host;
determining that the LED pin is asserted, turning an amber LED into a forward state, flowing a current through a current limit resistor, and allowing the host signal to go through a first MOSFET to turn on the first MOSFET and allow the current to pass through the first MOSFET and short a gate voltage of a second MOSFET so that the second MOSFET is placed in an off state which turns a blue LED to the off state;
determining that the LED pin is de-asserted such that no current flows to the amber LED, the amber LED is turned to the off state, a gate of the first MOSFET gets a low host signal and the first MOSFET is turned off so that no current flows through the first MOSFET which turns off the first MOSFET and turns on the second MOSFET, and turns the blue LED into the forward state; and
determining that there is a high impedance such that the current that flows through a first resistor and a first current limit resistor is insufficient to turn on the amber LED, and the current turns on the first MOSFET which turns off the second MOSFET and puts the blue LED in the off state.
